(19) United States
(12) Patent Application Publication
(10) Pub. No.: US 2026/0245414 A1
(43) Pub. Date: Aug. 20, 2026

(54) DISC COLLECTION AND RETURN SYSTEM AND METHODS PERFORMING THE SAME

(71) Applicant: Guy Dela Rosa, Holland, PA (US)

(72) Inventor: Guy Dela Rosa, Holland, PA (US)

(21) Appl. No.: 19/314,933

(22) Filed: Aug. 29, 2025

Related U.S. Application Data
(60) Provisional application No. 63/666,989, filed on Jul. 2, 2024.

(51) Int. Cl. G07C 9/00; A63B 65/10; A63B 67/06; E05B 49/00; H04W 4/14

(52) U.S. Cl. CPC G07C 9/00309; A63B 65/10; E05B 49/00; H04W 4/14; A63B 67/06; G07C 2009/00468; G07C 2009/00769

(57) ABSTRACT

A system for managing the collection and return of disc golf discs featuring a self-service pickup kiosk are disclosed. The system alleviates the need for owners and custodians to coordinate in-person meetings to return lost discs. The pickup kiosk communicates disc availability and system status to disc owners and custodians via short message service/multimedia messaging service (SMS/MMS) text communication. One-time use access codes are paired with owner phone numbers to provide two-factor authentication for access control to the discs stored in the pickup kiosk. Automated status messages allow custodians to remotely monitor pickup kiosk activities and operational readiness.

### CROSS-REFERENCE TO RELATED APPLICATIONS

This application claims the benefit of provisional patent application Ser. No. 63/666,989, filed 2024 Jul. 2 by the present inventor.

### PRIOR ART

The PDGA (Professional Disc Golf Association) was established in 1976 and serves as the sport's governing body. The PDGA Technical Standards dictate the physical constraints a disc must meet to be approved for use. Most discs range in mass from 150 to 180 grams with a typical disc having an overall diameter of 22 cm and an overall height of 2.1 cm.

There are over ten thousand (10,000) disc golf courses in the United States with over 90 percent being free to play. These courses are predominantly in public parks and served by local disc golf club volunteers and/or by municipal employees. Aside from the few private courses, there are no on-site staff to attend to players. Disc golf is largely a self-directed activity.

Lost discs are a common problem and devices been made to aid in the locating and retrieving of discs. Hammond, U.S. Pat. No. 12,330,025 discloses a ball of suction cups attached to telescopic pole for retrieving discs that are hard to reach. Martin, U.S. Pat. No. 9,579,552 discloses a removable Bluetooth location transmitter that attaches to a disc and is used in conjunction with a smartphone app to aid in tracking. Messenger, U.S. Pub. No. 2024/0238662 discloses an illuminating bag insert for recharging glow-in-the-dark discs during play in lowlight conditions.

Owners label discs with their mobile phone number to increase the chance that a lost disc will be returned. Some owners post photos of their lost discs on social media and offer rewards for their return.

Many disc golf clubs install drop boxes at disc golf courses as a courtesy for finders to avoid having to contact owners directly. These drop boxes and the disc return system processes are largely overseen by volunteer custodians.

Presently it is common practice for discs to be returned to owners in-person. Custodians send owners text messages with pickup details-when the drop box will be open and how long a disc will be held. Since there is no on-site staff, drop boxes are rarely open more than a few hours per week. This gravely impacts the return rate of discs to their owners.

Furthermore, when drop boxes are opened, they are frequently unsupervised. This increases the risk that discs are taken by players other than the rightful owners. It is well-known that some drop boxes hold over one hundred (100) discs. These drop boxes become targets for vandals to either fish discs out through the drop slot, or to break into the drop box and clear out the contents. These two factors further degrade the return rate of discs to their owners.

In this current state, each disc on-hand represents an additional text message for the custodian to send and another in-person exchange for the custodian to arrange with an owner. For courses receiving 10 to 20 discs per week, the burden is overwhelming, and discs accumulate quickly. Over time, discs are eventually declared to be abandoned and are sold to raise money for the local disc golf club.

One prominent custodian attests that mailing discs back to owners is his preferred method of return. Another prominent custodian attests to carrying over one hundred (100) discs in her personal automobile and having returned over one thousand (1,000) discs to owners in a single year.

Custodians have attempted to improve disc return rates by posting disc photos to social media and creating public disc databases to increase owner awareness and moving discs to off-site retail locations to increase accessibility. Custodians sometime employ third-party text messaging services to reduce the use of their personal mobile phones.

Even with these countermeasures in place, disc return rates remain very low.

### BACKGROUND OF THE INVENTION

The present invention relates to disc golf. In particular, the invention relates to a disc return system incorporating a self-service pickup kiosk.

Self-service and automated dispensing devices have been developed for a wide variety of articles; however, these legacy machines are ill-suited for discs.

The physical constraints of PDGA approved discs are clearly defined and the range of expected physical properties of commercially available discs are well-known. This information can be used to reduce the design complexity of a pickup kiosk.

Rapid development in the domain of single board computers has led to the proliferation of compact, high performance, low power, low-cost options in the marketplace. In addition, the internet-of-things (IoT) revolution has brought with it a wide variety of affordable options for connecting these single board computers to wireless networks. short message service/multimedia messaging service (SMS/MMS) text communication is the preferred form of communication between custodians and owners. The expansion of wireless network coverage by carriers have left few areas untouched by cellular communication.

Local disc golf clubs are staffed by volunteers and want solutions that are low cost, low complexity, and low maintenance. Custodians want solutions that are effective and efficient to return discs to their rightful owners within their time constraints. Owners want a convenient way to get their discs back.

Thus, there is a need for an improved disc return system. This system should allow owners to retrieve their discs at a time of their choosing and reduce the administrative and physical workload on custodians.

### SUMMARY OF THE INVENTION

Thus, it is an object of the present invention to provide an improved disc return system.

It is another object of the present invention to provide an improved disc return system which provides around-the-clock access to owners wishing to retrieve their discs.

It is another object of the present invention to provide an improved disc return system which constrains access to discs by using two-factor authentication.

It is another object of the present invention to provide an improved disc return system which reduces the need for custodians to use their personal mobile phones to communicate with owners.

It is another object of the present invention to provide an improved disc return system which automatically communicates status updates and error conditions when custodians and owners interact with the pickup kiosk.

It is another object of the present invention to provide an improved disc return system which communicates the operational state of the pickup kiosk to the custodian.

The above and other objects of the invention are realized in specific illustrated embodiments of a disc return system including a pickup kiosk with wireless network connectivity.

### BRIEF DESCRIPTION OF DRAWINGS

The foregoing and other features of the disclosure will become more fully apparent from the following description and appended claims, taken in conjunction with the accompanying drawings.

FIG. 1A is an environmental system block diagram showing the present invention in context of prior art.

FIG. 1B is a detailed view of a disc.

FIG. 1C is a detailed view of a custodian mobile phone.

FIG. 1D is a detailed view of an owner mobile phone.

FIG. 2 is a block diagram of a pickup kiosk.

FIG. 3A is a front view of a wall-mounted kiosk.

FIG. 3B is a side view of a vertical disc locker.

FIG. 3C is a front view of a free-standing kiosk.

FIG. 3D is a top view of a pitched disc locker.

FIG. 4 is a front view of a controller.

FIG. 5 is a block diagram of an exemplary set of pickup kiosk electronics.

FIG. 6A is a disc return system flow diagram showing the point-to-point movements of a disc and the associated network communications.

FIG. 6B is a block diagram of an exemplary disc data record.

FIG. 6C is a block diagram of an exemplary export data record.

FIG. 6D is a block diagram of an exemplary transaction data record.

FIG. 6E is a block diagram of an exemplary kiosk status record.

FIG. 7 is a flowchart of an exemplary method of operating a pickup kiosk.

### DETAILED DESCRIPTION OF THE INVENTION

In the following detailed description, reference is made to the accompanying drawings. The illustrative embodiments described herein are not meant to be limiting. Other embodiments may be utilized, and other changes may be made, without departing from the spirit or scope of the subject matter presented. Various features are described herein which may be exhibited by some embodiments and not by others. It will be readily understood that the aspects of the present disclosure and illustrated in the figures can be arranged, substituted, combined, and designed in a wide variety of different configurations by a person of ordinary skill in the art, all of which are made part of this disclosure.

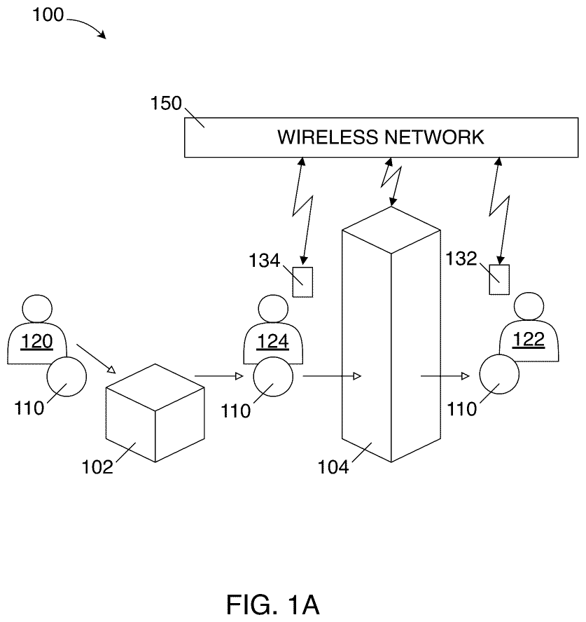

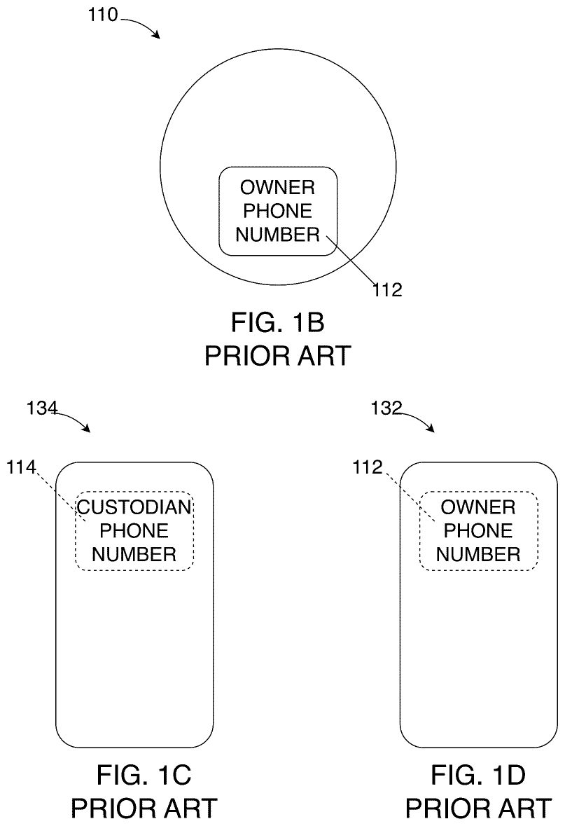

FIG. 1A shows the elements of the disc return system 100.

The elements consist of two components installed at the disc golf course, three wireless communication devices, three system participants, and a wireless network 150. The three system participants are: the finder 120, the custodian 124, and the owner 122. The two components installed at the disc golf course are the drop box 102 and the pickup kiosk 104. The three wireless communication devices are the custodian mobile phone 134, the owner mobile phone 132, and the pickup kiosk 104. In some embodiments, the wireless network 150 supports short message service/multimedia messaging service (SMS/MMS) text communication.

The arrows show how the disc 110 moves through the disc return system 100 in four steps; from initial drop off of the disc 110 by the finder 120 into the drop box 102, to removal of the disc 110 from the drop box 102 by the custodian 124, to insertion of the disc 110 into the pickup kiosk 104 by the custodian 124, to retrieval of the disc 110 from the pickup kiosk 104 by the owner 122.

FIG. 1B shows a simplified view of a disc 110 with an owner phone number 112. It is common practice for owners 122 to write the owner phone number 112 on the disc 110 in permanent marker. The owner phone number 112 is the primary means of determining rightful ownership of the disc 110.

FIG. 1C shows a simplified view of a custodian mobile phone 134.

FIG. 1D shows a simplified view of an owner mobile phone 132.

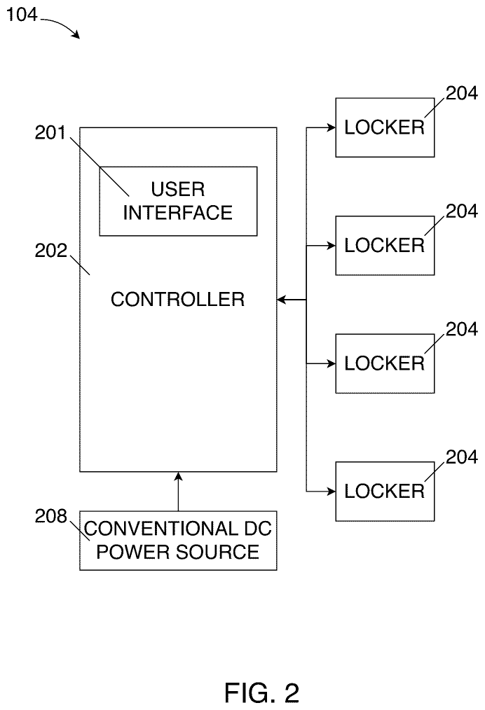

FIG. 2 shows a block diagram of a pickup kiosk 104. It includes a controller 202, a plurality of lockers 204, and a conventional DC power source 208. In some embodiments, the conventional DC power source 208 comprises a battery and a solar array trickle charger. In some embodiments, the conventional DC power source 208 comprises an AC-to-DC converter.

The controller 202 provides the means for a user interface 201.

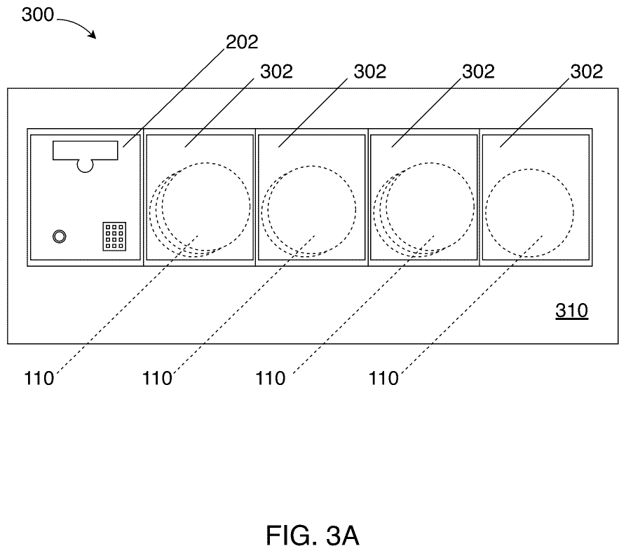

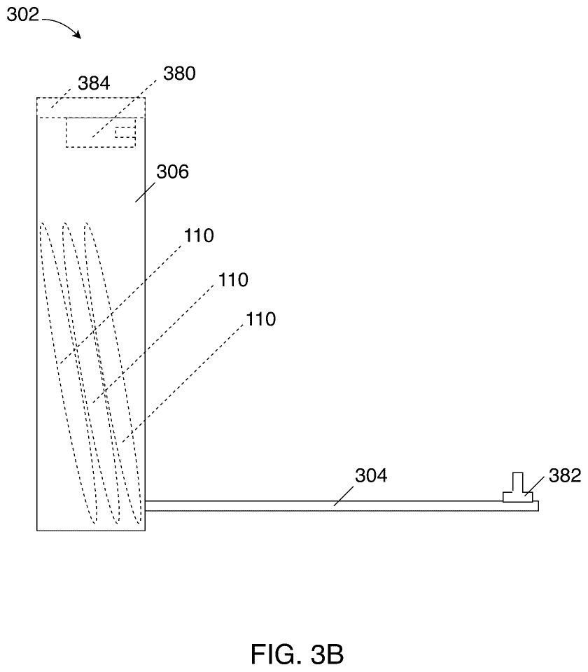

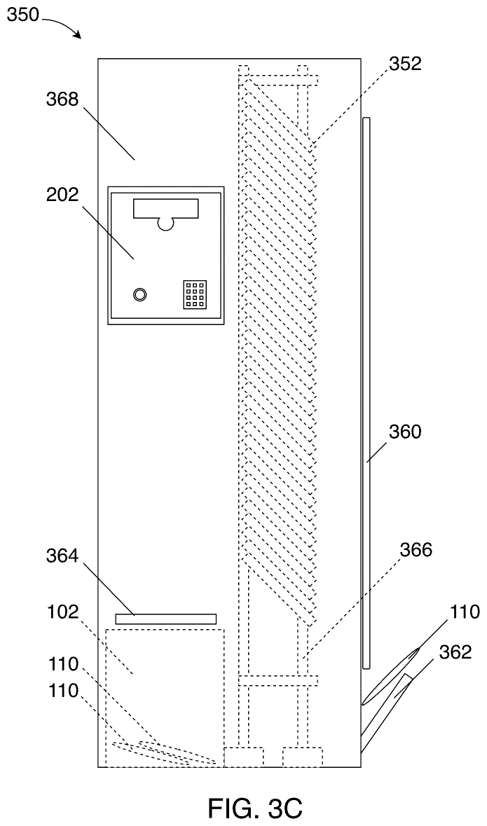

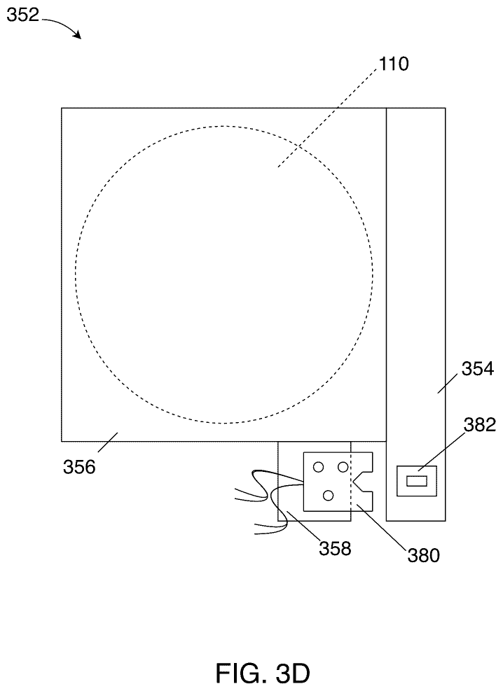

FIG. 3A shows a front view of an exemplary wall-mounted kiosk 300 as the first embodiment of a pickup kiosk 104. It includes a controller 202 and a plurality of vertical disc lockers 302 mounted to a support structure 310. Power is supplied to the controller 202 by a conventional DC power source 208.

In some embodiments, the support structure 310 is part of a pre-existing structure on the disc golf course such as the back of a course information board, an outer wall of a maintenance shed, or a chain link fence.

FIG. 3B shows a side view of an exemplary vertical disc locker 302. Normally, the locker door 304 is held closed by an electronic latch 380. The controller 202 provides the means to command the electronic latch 380 to open and to sense if the locker door 304 is open or closed. The electronic latch 380 forces the locker door 304 open by expelling the striker plate 382. The electronic latch 380 is held in place by latch support bracket 384. The vertical disc locker housing 306 is of predetermined size to hold a plurality of discs 110.

FIG. 3C shows a front view of an exemplary free-standing kiosk 350 as the second embodiment of a pickup kiosk 104. It includes a controller 202 and a plurality of pitched disc lockers 352 mounted on an internal rack 366 inside an external housing 368. The controller 202 contains the means to open the pitched lockers 352. Power is supplied to the controller 202 by a conventional DC power source 208.

The external housing 368 provides the means of custodial access to load a disc 110 and the means of owner access to retrieve a disc. In some embodiments, the means of custodial access comprises one or more lockable custodian access doors 360. In some embodiments, the means of owner access comprises a disc retrieval door 362.

In some embodiments, the free-standing kiosk 350 provides the means for dropping off discs 110. In some embodiments, the means of dropping off comprises a drop-off slot 364 cut into a face of the external housing 368 and a drop box 102 inside the external housing 368.

FIG. 3D shows a top view of an exemplary pitched disc locker 352. The pitched disc locker housing 356 is of predetermined size to hold one or more disc 110. The trap door 354 is held closed by the electronic latch 380. The electronic latch 380 forces the trap door 354 open by expelling the striker plate 382. The electronic latch 380 is held in place by latch mounting bracket 358.

In some embodiments, the electronic latch 380 and striker plate 382 are mounted on the exterior of the pitched disc locker 352 to avoid interference with the disc 110. The pitched disc lockers 352 are mounted in the free-standing kiosk 350 at a predetermined orientation to allow the disc 110 to fall out when the trap door 354 opens.

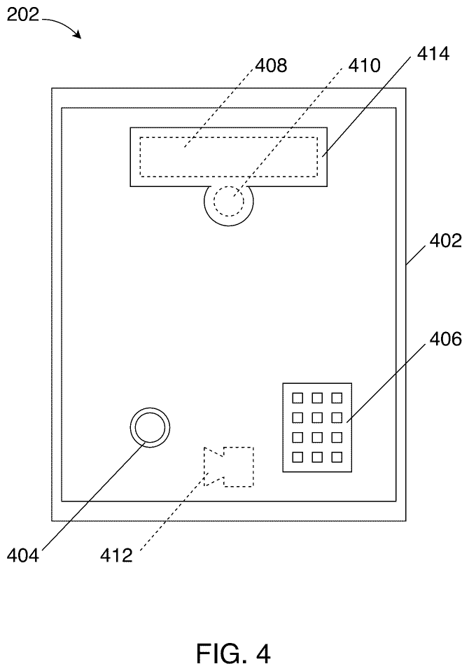

FIG. 4 shows the front view of an exemplary controller 202. In some embodiments, the user interface 201 comprises the switch 404, the keypad 406, the display 408, the camera 410, and the annunciator 412. In some embodiments, the switch 404 and keypad 406 are mounted on the front face of the controller housing 402. In some embodiments, the display 408 and camera 410 are mounted behind a viewing window 414.

In some embodiments, the electronic latches 380 comprises solenoid latch locks. In some embodiments, the electronic latches 380 comprises titanium wire locks.

In some embodiments, switch 404 comprises a momentary switch.

In some embodiments, the keypad 406 comprises a water-resistant 12-key keypad.

In some embodiments, the display 408 comprises a 2-row by 16-character organic light-emitting diode (OLED) display. In some embodiments, the display 408 comprises a full high definition (HD) liquid crystal display (LCD) screen.

In some embodiments, the annunciator 412 comprises a buzzer mounted inside the controller housing 402 that produces a tone in response to buttons on the keypad 406 being pressed.

In some embodiments, the viewing window 414 comprises a sheet of polycarbonate of predetermined size, an anti-reflective film or coating, and a Fresnel lens.

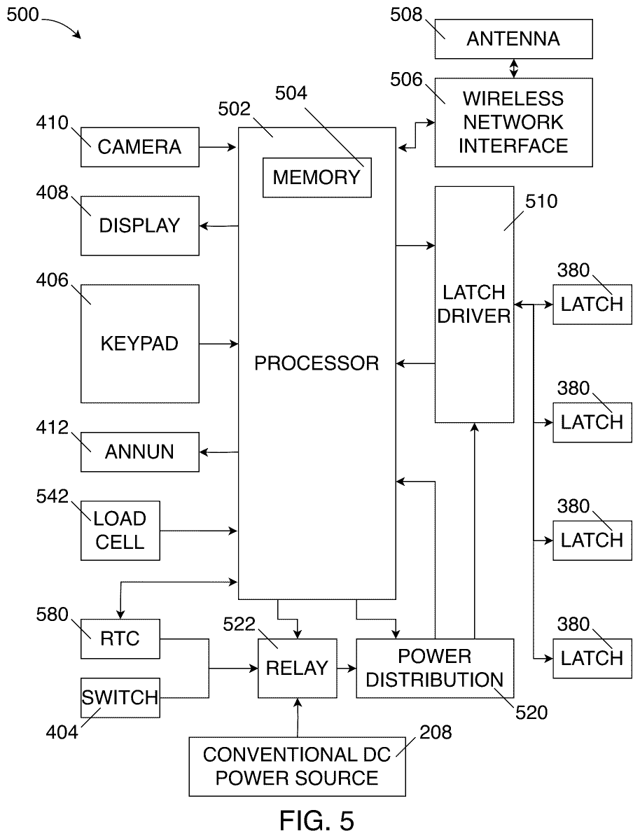

FIG. 5 shows the block diagram of an exemplary set of pickup kiosk electronics 500.

The following elements are generally available as commercial-off-the-shelf (COTS) items: electronic latches 380, switch 404, keypad 406, display 408, camera 410, annunciator 412, processor 502, memory 504, wireless network interface 506, antenna 508, relay 522, load cell circuitry 542, and real time clock 580. The annunciator 412 is denoted in FIG. 5 by the abbreviation ANNUN. The real time clock 580 is denoted in FIG. 5 by the abbreviation RTC.

In some embodiments, the relay 522 comprises a bi-stable relay.

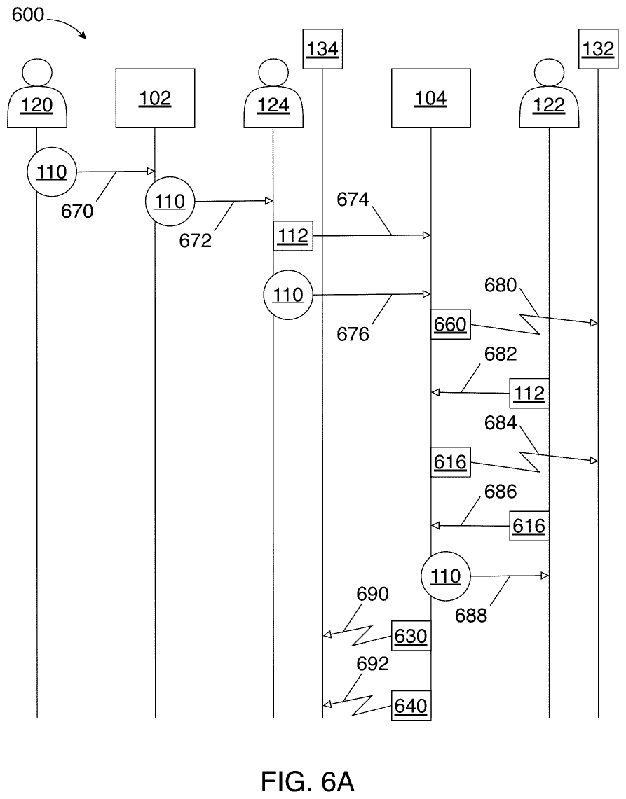

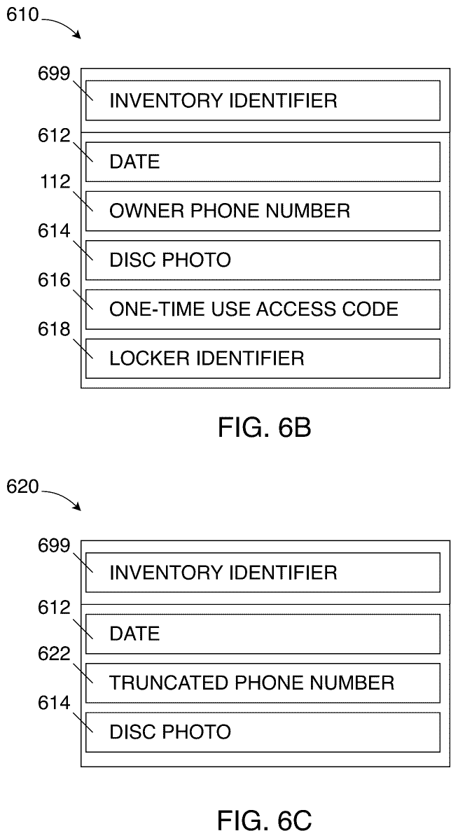

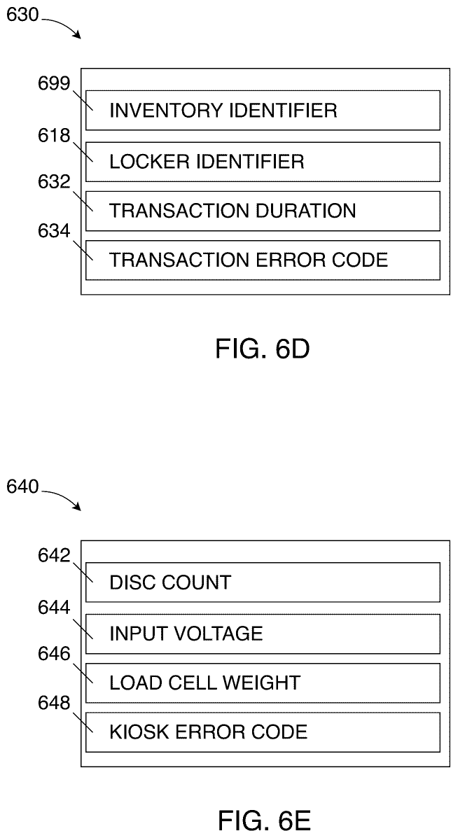

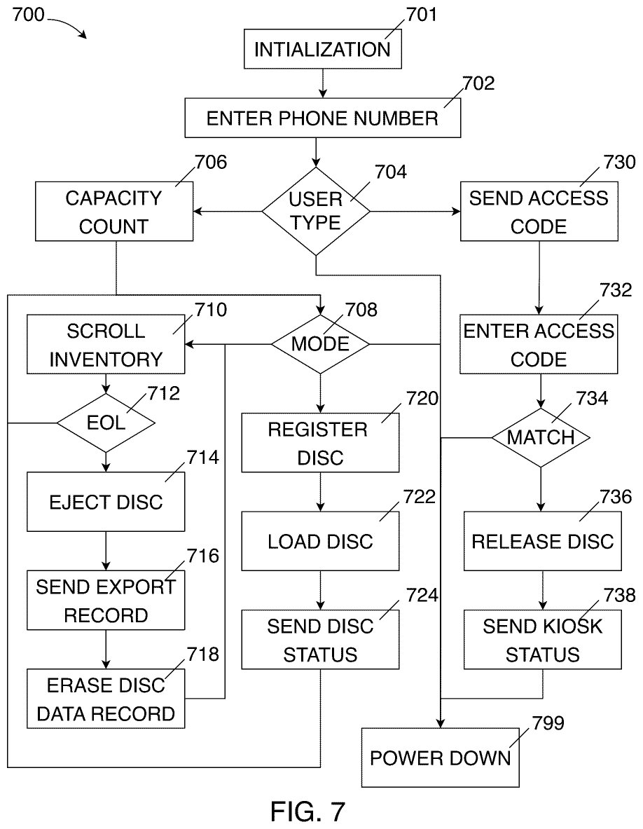

FIG. 6A is a flow diagram of an exemplary process 600. FIG. 6A shows the actions performed as a disc 110 moves through the disc return system 100. The process 600 comprises three phases aligned with the actions of the finder 120, the custodian 124, and the owner 122. An exemplary method 700 of operating a pickup kiosk 104 is described in greater detail with reference to FIG. 7.

The process 600 begins with action 670 wherein the finder 120 deposits the disc 110 in the drop box 102. At this point, phase 1 is complete and the process 600 pauses until the custodian 124 visits the drop box 102. In the intervening time, discs 110 accumulate in the drop box 102 as other finders 120 deposit discs 110.

Phase 2 of process 600 commences with action 672 when the custodian 124 removes the disc 110 from the drop box 102. As part of action 674, the custodian 124 examines the disc 110 to determine the owner phone number 112 and enters it into the pickup kiosk 104 via the user interface 201. The process 600 continues to action 676 wherein the custodian 124 physically loads the disc 110 into a locker 204. The process 600 continues to action 680 wherein the pickup kiosk 104 sends a disc status message 660 to the owner mobile phone 132. At this point, phase 2 is complete and the process 600 pauses until the owner 122 visits the pickup kiosk 104.

Phase 3 of the process 600 commences with action 682 wherein the owner 122 visits the pickup kiosk 104 and enters the owner phone number 112 via the user interface 201. The pickup kiosk 104 responds with action 684 wherein the pickup kiosk 104 sends the one-time use access code 616 to the owner mobile phone 132. At action 686, the owner 122 types in the one-time use access code 616 into the pickup kiosk 104 via the user interface 201. The pickup kiosk 104 responds with action 688 wherein the pickup kiosk 104 releases the disc 110 to the owner 122.

Phase 3 of the process 600 continues to action 690 wherein the pickup kiosk 104 sends a transaction data record 630 to the custodian mobile phone 134. The process 600 concludes with action 692 wherein the pickup kiosk 104 sends a kiosk status record 640 to the custodian mobile phone 134.

FIG. 6B through 6E show block diagrams of exemplary disc data record 610, export data record 620, transaction data record 630, and kiosk status record 640 respectively. In some embodiments, an inventory identifier 699 is automatically generated by the pickup kiosk 104 when the disc 110 is initially stored in the pickup kiosk 104. This inventory identifier 699 can uniquely identify the disc 110 throughout the process 600. It can appear in the disc data record 610, the export data record 620, and transaction data record 630.

In some embodiments, a disc photo 614 is used to as a means for custodian 124 and owners 122 to unambiguously identify the disc 110. In some embodiments, the disc data record 610 comprises the owner phone number 112 as a means for identifying the owner 122. In some embodiments, the export data record 620 comprises a truncated phone number 622 as a means for an initial ownership screening. In some embodiments, the truncated phone number 622 comprises the last four digits of the owner phone number 112.

In some embodiments, the disc data record 610 comprises the one-time use access code 616 and locker identifier 618. In some embodiments, the transaction data record 630 comprises the locker identifier 618 as a means for informing the custodian 124 which locker 204 has a vacancy.

In some embodiments, the disc data record 610 comprises the date 612 denoting when the disc 110 was initially stored in the pickup kiosk 104 as a means for determining how long a disc 110 has been stored. In some embodiments, the export data record 620 comprises the date 612 as a means for determining if the disc 110 should be considered abandoned.

In some embodiments, the transaction data record 630 comprises a transaction duration 632 as a means for informing the custodian 124 how long an owner 122 interacted with the pickup kiosk 104 when retrieving a disc 110. In some embodiments, the transaction data record 630 comprises a transaction error code 634 as a means for informing the custodian 124 of an unexpected occurrence during a transaction.

In some embodiments, the kiosk status record 640 comprises a disc count 642 as a means for informing the custodian 124 how many discs 110 are stored in the pickup kiosk 104. In some embodiments, the kiosk status record 640 comprises a measurement of the input voltage 644 as a means for informing the custodian 124 of the health of the conventional DC power source 208. In some embodiments, the kiosk status record 640 comprises a measurement of the load cell weight 646 as a means for informing the custodian 124 how many discs 110 are in the drop box 102. In some embodiments, the kiosk status record 640 comprises a kiosk error code 648 as a means for informing the custodian 124 of a condition requiring intervention.

FIG. 7 is a program flowchart illustrating an exemplary method 700 of operating a pickup kiosk 104.

The method 700 starts at block 701 in response to switch 404 being activated. The switch 404 triggers relay 522 to apply power from the conventional DC power source 208 to the processor 502 via the power distribution circuitry 520. As part of block 701, the processor 502 performs housekeeping functions and sets a watchdog timer. The watchdog timer is used by the processor 502 to power down the pickup kiosk 104 in an orderly manner after a predetermined duration of inactivity.

In some embodiments, the means for performing the watchdog timer function comprises a real time clock 580.

The method 700 continues to block 702 wherein the user is prompted for the first data entry via the user interface 201. The method 700 continues to decision state 704 wherein the processor 502 determines the user type. The processor 502 determines user type by first comparing the first data entry to the custodian phone numbers 114 stored in memory 504. If there is a match, the method 700 proceeds to block 706. If there is not a match, the processor 502 compares the first data entry to the owner phone numbers 112 in the disc data records 610. If a match is found, the method 700 proceeds to block 730. If no match is found, the processor 502 checks if a predetermined threshold of first data entry attempts has been reached. If so, the method 700 branches to block 799; otherwise, the method 700 returns to block 702.

At block 706, the processor 502 calculates the number of available disc storage locations remaining and presents this information via the user interface 201 then proceeds to decision state 708. At decision state 708, the user is prompted for a second data entry via the user interface 201. The three mode options presented to the user are a) Add Discs, b) Remove Discs, or c) Quit. If the user selects the Add Discs option, the method 700 proceeds to block 720. If the user selects the Remove Discs option, the method 700 proceeds to block 710. If the user selects the Quit option, the method 700 branches to block 799.

At block 710, the processor 502 presents the user with an ordered list of the disc data records 610 for review via the user interface 201. The user scrolls through the list and selects a disc data record 610. The method 700 proceeds to decision state 712 wherein the processor 502 checks if the user reached the end of list (EOL) without selecting a disc data record 610. If so, the method 700 returns to decision state 708, otherwise, the method 700 proceeds to block 714.

At block 714, the processor 502 retrieves the locker identifier 618 from the disc data record 610 and commands the latch driver 510 to open the electronic latch 380 associated with locker identifier 618. Block 714 concludes by displaying a message on the user interface 201 that the disc 110 is ready for removal from the pickup kiosk 104. The method 700 proceeds to block 716 wherein the processor 502 extracts a subset of data from the disc data record 610 to create an export data record 620. Block 716 concludes with the processor 502 commanding the wireless network interface 506 to send the export data record 620 to the custodian phone number 114.

The method 700 proceeds to block 718 wherein the processor 502 erases the disc data record 610 from memory 504. Thereafter, the method 700 returns to block 710.

At block 720, the processor 502 prompts the user to enter the owner phone number 112 found on the disc 110 and to use the camera 410 to capture a disc photo 614 via the user interface 201. The method 700 continues to block 722.

In some embodiments, the pickup kiosk 104 is configured to send multimedia messaging service (MMS) text messages with the disc photo 614 to the custodian phone number 114 as a means for performing a visual review.

At block 722, the user is prompted to insert the disc 110 into a locker 204. The processor 502 detects which locker 204 has been opened/closed by monitoring the state of the electronic latches 380 and assigns the appropriate locker identifier 618. The processor 502 then randomly generates a one-time use access code 616. Block 722 concludes with the processor 502 linking the captured data elements—date 612, owner phone number 112, disc photo 614, a one-time use access code 616, and locker identifier 618—into a disc data record 610 and assigns an inventory identifier 699.

In some embodiments, the inventory identifier 699 is a uniquely generated identifier encoding the month/year of the date 612 and the cumulative number of disc data records 610 created in the month.

The method 700 proceeds to block 724 wherein the processor 502 commands the wireless network interface 506 to send a disc status message 660 to the owner phone number 112. In some embodiments, the disc status message 660 includes instructions on how to retrieve the disc 110. In some embodiments, the disc status message 660 includes the disc photo 614. At the conclusion of block 724, the method 700 returns to decision state 708.

At block 730, the processor 502 commands the wireless network interface 506 to send the one-time use access code 616 from the disc data record 610 to the owner phone number 112. The method 700 proceeds to block 732 wherein the user is prompted for a third data entry via the user interface 201. The method 700 proceeds to decision state 734 wherein the processor 502 determines if the third data entry matches the one-time use access code 616. If a match is confirmed, the two-factor authentication is complete and method 700 proceeds to block 736. If a mismatch is found, the processor 502 determines if a predetermined threshold of third data entry attempts has been reached. If so, the method 700 branches to block 799; otherwise, the method 700 returns to block 732.

At block 736, the processor 502 retrieves the locker identifier 618 from the disc data record 610 and commands the latch driver 510 to open the electronic latch 380 associated with locker identifier 618. Block 736 concludes by displaying a message on the user interface 201 that the disc 110 is ready for retrieval from the pickup kiosk 104. Block 736 concludes with the processor 502 erasing the disc data record 610 from memory 504. The method 700 proceeds to block 738.

At block 738, the processor 502 first commands the wireless network interface 506 to send transaction data record 630 to the custodian phone number 114. The processor 502 then gathers kiosk status data from the latch driver 510, the power distribution 520, and the load cell circuitry 542. Block 738 concludes with the processor 502 commanding the wireless network interface 506 to send the kiosk status record 640 to the custodian phone number 114. Thereafter, the method 700 proceeds to block 799.

At block 799, the processor 502 performs housekeeping functions then triggers the relay 522 to open, thereby removing power from the controller 202 and placing the pickup kiosk 104 in an unpowered state.

I claim:

1. A system for facilitating the collection and return of lost discs comprising:
a. a drop box,
b. a pickup kiosk,
c. a wireless network,
d. a plurality of owner mobile phones communicably connected to the pickup kiosk via the wireless network, and
e. one or more custodian mobile phone communicably connected to the pickup kiosk via the wireless network.

2. The system as recited in claim 1, wherein the pickup kiosk is further adapted to facilitate the use of individually lockable lockers for exchange of the discs by one or more custodian and a plurality of owners.

3. The system as recited in claim 2, wherein the pickup kiosk is further adapted to facilitate the creation and maintenance of a disc data record, the disc data record comprising an inventory identifier, an owner phone number, a one-time use access code, an assigned locker identifier, and date of the disc data record creation.

4. The system as recited in claim 3, wherein the pickup kiosk is further adapted to provide access to the discs in the individually lockable lockers based on two-factor authentication of the owner phone number and the one-time use access code.

5. The system as recited in claim 3, wherein the pickup kiosk is further adapted to capture a disc photo and append the disc photo to the disc data record.

6. The system as recited in claim 1, wherein the pickup kiosk is further adapted to send a disc status message to the owner mobile phone.

7. The system as recited in claim 1, wherein the pickup kiosk is further adapted to send transaction data records and kiosk status records to the custodian mobile phones.

8. The system as recited in claim 1, wherein the wireless network supports short message service/multimedia messaging service (SMS/MMS) text communication.

9. A pickup kiosk for the collection and return of lost discs, the pickup kiosk comprising:
a. a plurality of individually lockable lockers for storage of one or more discs, and
b. a controller for controlling the locking and unlocking of the individually lockable lockers.

10. The pickup kiosk as recited in claim 9, wherein the controller is further adapted to facilitate the creation and maintenance of a disc data record, the disc data record comprising an inventory identifier, an owner phone number, a one-time use access code, an assigned locker identifier, and date of the disc data record creation.

11. The pickup kiosk as recited in claim 10, wherein the controller is further adapted to provide access control to the individually lockable lockers based on two-factor authentication of the owner phone number and the one-time use access code.

12. The pickup kiosk as recited in claim 11, wherein the controller is further adapted to communicate with the owner mobile phones associated with the owner phone numbers via short message service/multimedia messaging service (SMS/MMS) text communication.

13. The pickup kiosk as recited in claim 10, wherein the controller is further adapted to capture a disc photo and append the disc photo to the disc data record.

14. The pickup kiosk as recited in claim 10, wherein the controller is further adapted to send a disc status messages to the owner mobile phone associated with the owner phone number.

15. The pickup kiosk as recited in claim 9, wherein the controller is further adapted to register one or more users as custodians with separate custodian phone numbers.

16. The pickup kiosk as recited in claim 15, wherein the controller is further adapted to communicate with the custodian mobile phones associated with the custodian phone numbers via short message service/multimedia messaging service (SMS/MMS) text communication.

17. The pickup kiosk as recited in claim 15, wherein the controller is further adapted to send transaction data records and kiosk status records to the custodian mobile phones associated with the custodian phone numbers.

18. A method for facilitating the collection and return of lost discs, the method comprising:
a. providing a drop box,
b. providing a pickup kiosk comprising a plurality of individually lockable lockers for storage of one or more discs and a controller for controlling the locking and unlocking of the individually lockable lockers,
c. providing a wireless network,
d. removing the disc from the drop box,
e. storing the disc in an individually lockable locker of the pickup kiosk,
f. creating a disc data record representative of the disc, the data record comprising an owner phone number, a one-time use access code, and an assigned locker identifier,
g. sending the one-time use access code to the owner mobile phone associated with the owner phone number, and
h. opening the individually lockable locker containing the disc in response to a two-factor authentication of the owner phone number and the one-time use access code at the pickup kiosk.

19. The method as recited in claim 18, wherein the wireless network supports short message service/multimedia messaging service (SMS/MMS) text communication.

20. The method as recited in claim 18, wherein the disc data record comprises a disc photo.
